(19) United States
(12) Patent Application Publication
(10) Pub. No.: US 2015/0248382 A1
(43) Pub. Date: Sep. 3, 2015

(54) APPARATUS AND METHOD FOR CONVERTING AN ELECTRONIC FORM

(71) Applicants: Yong Ju Shin, Daejeon (KR); Kiseok Choi, Daejeon (KR); Jaesoo Kim, Daejeon (KR); Hongro Lee, Daejeon (KR); Kyu Chul Lee, Daejeon (KR); Seung Jun Cha, Daejeon (KR); Gyu Jin Chol, Chungcheongbuk-do (KR)

(72) Inventors: Yong Ju Shin, Daejeon (KR); Kiseok Choi, Daejeon (KR); Jaesoo Kim, Daejeon (KR); Hongro Lee, Daejeon (KR); Kyu Chul Lee, Daejeon (KR); Seung Jun Cha, Daejeon (KR); Gyu Jin Chol, Chungcheongbuk-do (KR)

(73) Assignee: KOREA INSTITUTE OF SCIENCE 7 TECHNOLOGY INFORMATION, Daejeon (KR)

(21) Appl. No.: 14/129,331

(22) PCT Filed: Nov. 12, 2013
(86) PCT No.: PCT/KR2013/010248

§ 371 Date: Dec. 26, 2013

(30) Foreign Application Priority Data
Nov. 12, 2012 (KR) 10-2012-00127671

(51) Int. Cl. G06F 17/22; G06F 17/24

(52) U.S. Cl. CPC G06F 17/2264; G06F 17/2247; G06F 17/243

(57) ABSTRACT

An apparatus and method for converting an electronic form. After a table is extracted as an image of information on a cell range instead of text by analyzing the table of the PDF document file requested according to a standard operation of the PDF document file requested to be converted and converting the analyzed table into the standard document based on the prescribed reference information, the standard document including information on cell range corresponding to the table of the converted PDF document is converted into the XML document according to the XML conversion format. In turn, as the XML document is structurized and provided according to the prescribed XML reference information and the XML document file, the PDF document file is accurately converted into the XML document file which is in turn provided, thereby improving the form conversion quality of the document, and also easily storing and managing the document.

### TECHNICAL FIELD

The present disclosure relates to an apparatus and a method for converting an electronic form, and more particularly, to an apparatus and a method for converting an electronic form, in which a table in a Portable Document Format (PDF) document file is rearranged in the form of cell range information, a standard document file including the rearranged cell range information is converted into an eXtensible Markup Language (XML) document file according to an XML format, an XML schema is obtained from the converted XML document file, and an XML structurization is implemented based on the obtained XML schema and prescribed reference information, thereby providing XML data.

### BACKGROUND ART

Recently, with rapid development of technologies relating to e-business, IT and the like, business management between enterprises is moving away from a process in which paper documents are exchanged and adopting a process in which electronic documents are electronically treated, and as such, business between enterprises is performed based on the electronic documents.

That is, by using electronic documents in a trading between business entities, efforts have been made to decrease a cost in treatment of a business, to reduce a trading time, and to increases efficiency and competitiveness in a management of the enterprises.

However, although use of such an electronic document is effective, the electronic document has still been used along with the paper document inside and outside of the country.

Further, conventional electronic documents include electronic documents in the various forms or formats, and these forms or formats of the electronic documents may become an obstacle in a smooth exchange of the electronic document and the business management through the exchange of the electronic document. These forms or formats of the electronic documents also may cause trouble in compatibility between systems, so as to increases an unnecessary cost in an operation such as a system change and an addition.

Especially, when a conversion engine is executed in order to convert the conventional Portable Document Format (PDF) file into an eXtensible Markup Language (XML) document file and to store the XML document file, there frequently occurs a phenomenon of a text being separated by non-text such as a figure, a table, and a footnote which are inserted in the PDF document file.

For this reason, when the PDF document file is converted into the XML document file, a table to be converted may not be stored, thereby causing an error in a text of an original document. Thus, there is a problem in that a quality of the conversion of the form is decreased.

### DISCLOSURE OF THE INVENTION

### Technical Problem

The present disclosure is made to solve the above-mentioned problems in the conventional art, and an aspect of the present disclosure is to provide an apparatus for converting an electronic form which includes a standard document generating unit which extracts information on a single line having a starting point and an ending point from information on a table which is analyzed according to a standard operation of a PDF document file request to be converted, based on a prescribed reference information, derives intersection information from the single line information, and extracts information on a cell range based on the intersection information, an XML document generating unit which converts a standard document including the information on the cell range according to the XML form converting format information when an XML form conversion information is input, and generates an XML document file, and an XML document file providing unit which structurizes and provides the XML document file according to a prescribed reference information in response to a request of the converted document, in which the XML document providing unit includes a schema acquiring unit which receives and processes the XML document file from the XML document generating unit and acquires a designated schema of an XML data stream from a schema repository, and a storing unit which acquires reference information designated in the input XML document file, structurizes and converts the XML document file into XML data based on the acquired reference information and the XML schema, and converts the XML document file into XML data, thereby accurately converting the table inserted in the PDF document file into the XML document file so as to improve a form conversion quality of the document fundamentally.

Another aspect of the present disclosure is to provide a method of converting an electronic form which includes generating a standard document in which information on a single line having a starting point and an ending point is extracted from information on a table which is analyzed according to a standard operation of a PDF document file request to be converted, based on prescribed reference information, intersection information is derived from the single line information, and information on a cell range is extracted based on the intersection information, generating an XML document in which a standard document including the information on the cell range is converted according to the XML form converting format information when an XML form conversion information is input, so as to generate an XML document file, and providing an XML document file in which the XML document file is structurized and provided according to a prescribed reference information in response to a request of the converted document, in which in the XML document is provided, after the XML document file of the XML document generating is received and processed, a designated schema of an XML data stream is acquired from a prescribed schema repository, reference information designated in the input XML document file is acquired, and the XML document file is structurized into XML data by converting the XML document file in the XML data based on the acquired reference information and the XML schema, thereby accurately converting the table inserted in the PDF document file into the XML document file so as to improve a form conversion quality of the document fundamentally.

### Solution to Problem

In accordance with an aspect of the present disclosure, there is provided an apparatus for converting an electronic form which analyzes a table of a PDF document file requested to be converted according to a standard operation of the PDF document file, derives cell range information from the analyzed table based on prescribed PDF reference information, converts the cell range information and a text of a standard document according to an XML form conversion format into an XML document, and structurizes and provides the converted XML document according to prescribed XML reference information. The apparatus includes a standard document converting unit configured to extract information on a table which is analyzed according to a standard operation of a Portable Document Format (PDF) document file requested to be converted as information on a single line having a starting point and an ending point based on prescribed reference information, to derive information on an intersection having at least one common starting point or ending point from the single line information, and to extract and store cell range information based on the intersection information; an eXtensible Markup Language (XML) document generating unit configured to convert a standard document having cell range information according to information on a prescribed XML form conversion format so as to generate an XML document file, when an XML form conversion request is input; and an XML document providing unit configured to XML structurize and provide the XML document file based on prescribed XML reference information in response to a conversion document request.

Preferably, the XML document providing unit includes: a schema acquiring unit configured to receive and treat the XML document file of the XML document generating unit and to acquire an XML schema designated in an XML data stream from a schema repository; and a storing unit configured to acquire reference information designated in the received XML document file, and to structurize and convert the XML document file into XML data based on the acquired reference information and the XML schema so as to provide the XML data.

In accordance with another aspect of the present disclosure, there is a method of converting an electronic form. The method includes: generating a standard document in a standard document converting unit, which includes extracting single line information having a starting point and an ending point, based on prescribed reference information from information on a table which is analyzed according to a standard operation of a Portable Document Format (PDF) document file requested to be converted, deriving information on an intersection, deriving intersection information from the single line information, and extracting cell range information from the intersection information;

generating an XML document in an XML document generating unit, which includes generating an XML document file by converting the standard document including the cell range information according to XML form conversion information, when the XML form conversion information is input; and

providing an XML document in an XML document providing unit, which includes XML structurizing the XML document according to prescribed reference information in response to a conversion document request of the XML document generating unit.

Preferably, in the XML document providing, a schema acquiring unit receives and treats an XML document file in the XML document generating and acquires an XML schema designated in XML data stream from prescribed schema repository, and a storing unit configured to acquire reference information designated in the received XML document file, and to structurize and convert the XML document file into XML data based on the acquired reference information and the XML schema so as to provide the XML data.

### Advantageous Effects

According to the present disclosure as described above, after the table is extracted as an image of information on a cell range instead of a text by analyzing the table of the PDF document file requested according to a standard operation of the PDF document file requested to be converted and converting the analyzed table into the standard document based on the prescribed reference information, the standard document including information on cell range corresponding to the table of the converted PDF document is converted into the XML document according to the XML form conversion format. In turn, as the XML document is structurized and provided according to the prescribed XML reference information and the XML document file, the PDF document file is accurately converted into the XML document file which is in turn provided, thereby fundamentally improving the format conversion quality of the document, and also easily storing and managing the document.

Although following drawings attached to the present disclosure illustrate a preferred embodiment of the present disclosure to help understanding of the technical spirit of the present disclosure along with the detailed description of the present disclosure as described below, the present disclosure should not be interpreted to be limited to elements depicted in the drawings.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a view illustrating a configuration of an electronic form conversion apparatus according to an embodiment of the present disclosure;

FIG. 2 is an exemplary view illustrating a table inserted in a PDF document file and a standard operation of converting the table according to the embodiment of the present disclosure;

FIG. 3 is an exemplary view illustrating information on a single line extracted from the table of the PDF document file according to the embodiment of the present disclosure;

FIG. 4 is an exemplary view illustrating an intersection which is derived from the information on the extracted single line according to the embodiment of the present disclosure;

FIG. 5 is an exemplary view illustrating information on a cell range which is extracted from the derived intersection according to the embodiment of the present disclosure;

FIG. 6 is an exemplary view illustrating a structurization of an XML document providing unit according to the embodiment of the present disclosure; and

FIG. 7 is a flowchart illustrating a configuration of an electronic form conversion apparatus according to an embodiment of the present disclosure.

### BEST MODE

### Mode for the Invention

In order to sufficiently understand the present disclosure, aspects of the embodiment of the present disclosure and merits of operation of the present disclosure, accompanying drawings showing the preferred embodiment of the present disclosure and contents described in the drawings must be referred to.

Hereinafter, a preferred embodiment of the present disclosure will be described in detail with reference to the accompanying drawings. Identical reference numerals shown in each drawing are used to indicate identical elements.

In the description below, specific details are shown and are provided to help the whole understanding of the present disclosure. In the following description of the present disclosure, a detailed description of known functions or configurations incorporated herein will be omitted when it may make the subject matter of the present disclosure rather unclear.

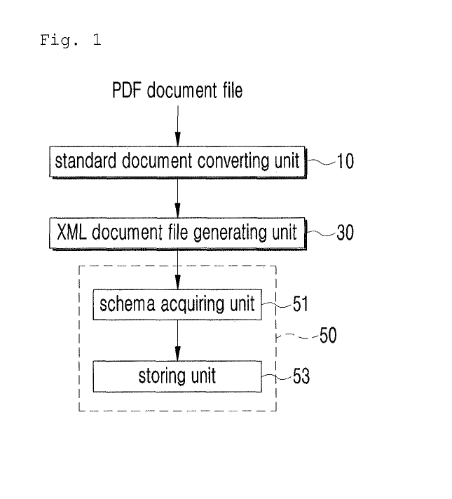

FIG. 1 is a view illustrating a configuration of an apparatus for converting an electronic form according to the present disclosure.

The apparatus for converting the electronic form according to the embodiment of the present disclosure includes a standard document converting unit 10, an XML document generating unit 30, and an XML document providing unit 50, as shown in FIG. 1.

The standard document converting unit 10 analyzes a table stored in the PDF document file according to a standard operation, and extracts information on the analyzed table as information on a single line which is set as coordinates for a starting point and an point based on prescribed reference information.

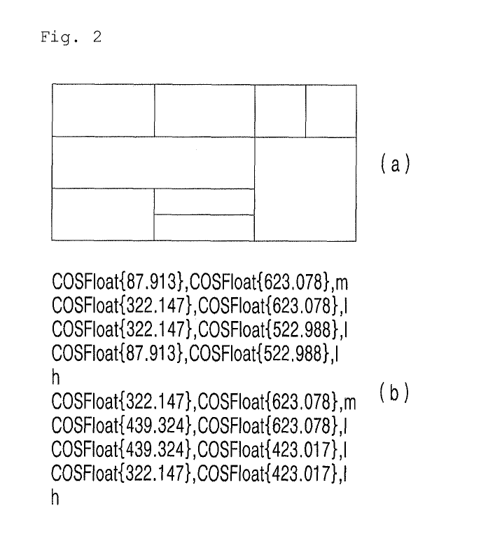

That is, in the case that the attached table is inserted in the PDF document file as shown in FIG. 2A, information on the table is stored through the standard operation as shown in FIG. 2B.

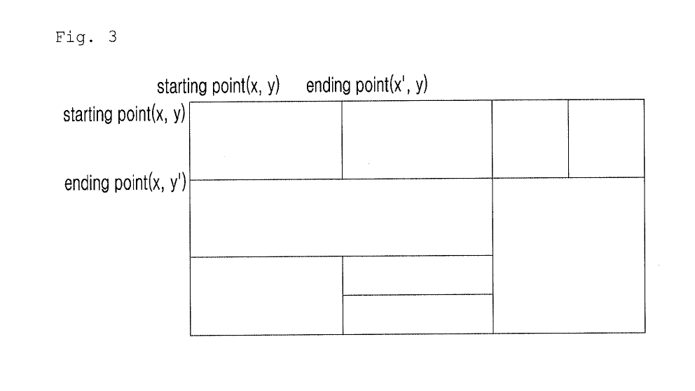

Further, the standard document converting unit 10 extracts information on the single line having the starting point (x, y) and the ending point (x′, y) which are set to the coordinates based on the table information and the prescribed reference information as shown in FIG. 3B. At this time, the single line information is shown in FIG. 3.

Further, the standard document converting unit 10 derives intersections for each single line from the single line information having coordinate information of the starting point and the ending point.

That is, the standard document converting unit 10 sets up a set A of the single line information of a horizontal line having a value identical to the ending point y and a set B of the single line information of a vertical line having a value identical to the starting point x, and derives information on a first single line L(x, y) (x′, y) from the set A of the single line information of the horizontal line and a first intersection (p, y) from the information on the first single line M(p, q) (p, q′) in the set B of the single line information of the vertical line.

For example, an intersection (p, y) having common values among the first single line information is derived based on the first single line information L(x, y) (x′, y) of the set A and the first single line information M(p, q) (p, q′) of the set B, and in the case where the derived intersection (p, y) is present within each desired range derived from each of two pieces of the first single line information L(x, y) and (x′, y), and M(p, q) (q, p′) of the sets A and B, the intersection is determined as an intersection and added to an intersection list N.

On the other hand, in the case where the derived intersection (p, y) is not present within each desired range derived from each of two pieces of the first single line information of the sets A and B, the first single line information L(x, y) (x′, y) of the set A and second single line information M(p, q′) (p, q″) of the set B are extracted, and in the case where the second single line information of the set B is not final single line information, the intersection is derived from the first single line information L(x, y) (x′, y) of the set A and the second single line information M(p, q′) (p, q″) of the set B.

Further, the standard document converting unit 10 extracts second single line information L(x′, y) (x″, y) of the set A and the first single line information M(p, q) (p, q′) of the set B when the second single line information of the set B is final single line information, and derives an intersection of the second single line information L(x′, y) (x″, y) of the set A and the first single line information M(p, q) (p, q′) of the set B when the second single line information of the extracted set A is not final single line information.

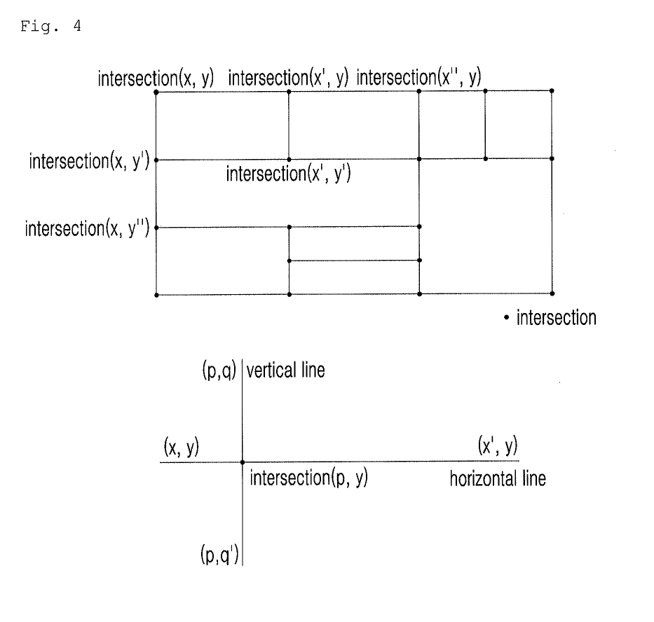

A serial process of deriving such an intersection is repeatedly executed until all single line information belonging to the sets A and B are completed. The derived intersection information is shown in FIG. 4.

On the other hand, the standard document converting unit 10 arranges coordinate information for each intersection of the intersection list when the extraction of all intersections is completed based on each piece of single line information, and then extracts and stores the cell range based on the set A of intersections which are located at an upper portion, a first intersection L of the set A, the set B of intersections which are located at a lower portion by reference of the first intersection L, and the first intersection M of the set B of intersections.

That is, the standard document converting unit 10 arranges coordinate information for each intersection of the intersection list, and then extracts the set A of intersections which are located at the upper portion, the first intersection L of the set A, the set B of intersections which are located at the lower portion by reference of the first intersection L, and the first intersection M of the set B of intersections.

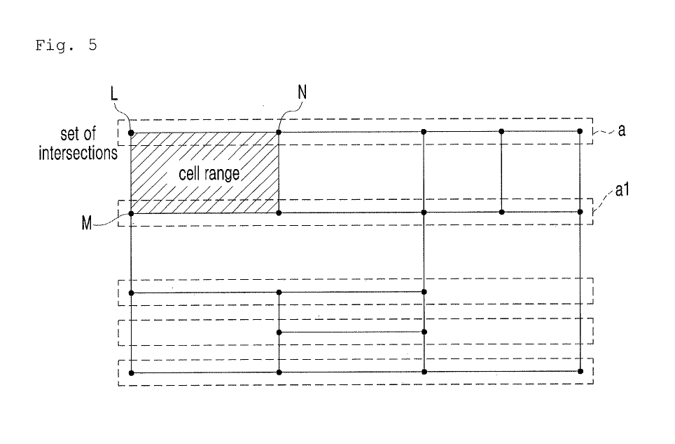

Furthermore, the standard document converting unit 10 extracts a second intersection N which is located by the first intersection L when a coordinate value of an x-axis of the first intersection L of the set A is identical to a coordinate value of the first intersection M of the set B, determines whether information on a single line passing the extracted second intersection N is present, and extracts and stores cell range information as the first intersection (L(x), L(y)) and the second intersection (N(x), N(y)) of the set A and the first intersection (M(x), M(y)) and the second intersection (N(x), M(y)) of the set B when the information on the single line passing the second intersection is present as a result of the determination. The cell range information derived through the serial process is shown in FIG. 5.

Moreover, the standard document converting unit 10 updates the first intersection L of the set A to the second intersection N, determines whether the updated first intersection L is a final intersection of the set A, updates the set which is located at the lower portion of the set A to the set A where the updated first intersection L is a final intersection of the set A as a result of the determination, and repeatedly executes the extraction and the storage of the cell range information until the updated set A is updated to the final set.

In addition, the cell range information of the standard document converting unit 10 is provided to the XML document generating unit 30 along with the standard document converted into the text based on the PDF reference information, and the XML document generating unit 30 converts the standard document including the cell range information according to the prescribed XML form conversion format information, so as to generate the XML document file and to provide the generated XML document file to the XML document providing unit 50.

The XML document providing unit 50 structurizes and provides the XML document file based on the prescribed XML reference information in response to a request for the converted document, and includes the schema acquiring unit 51 and the storing unit 53.

That is, the schema acquiring unit 51 receives and treats the XML document file of the XML document generating unit, and provides a schema to the storing unit 53 after acquiring the schema designated in the XML data stream from the schema repository, while the storing unit 53 acquires reference information designated in the input XML document file, structurizes and converts the XML document file based on the acquired reference information and the XML schema into the XML data, and provides the XML data to a memory.

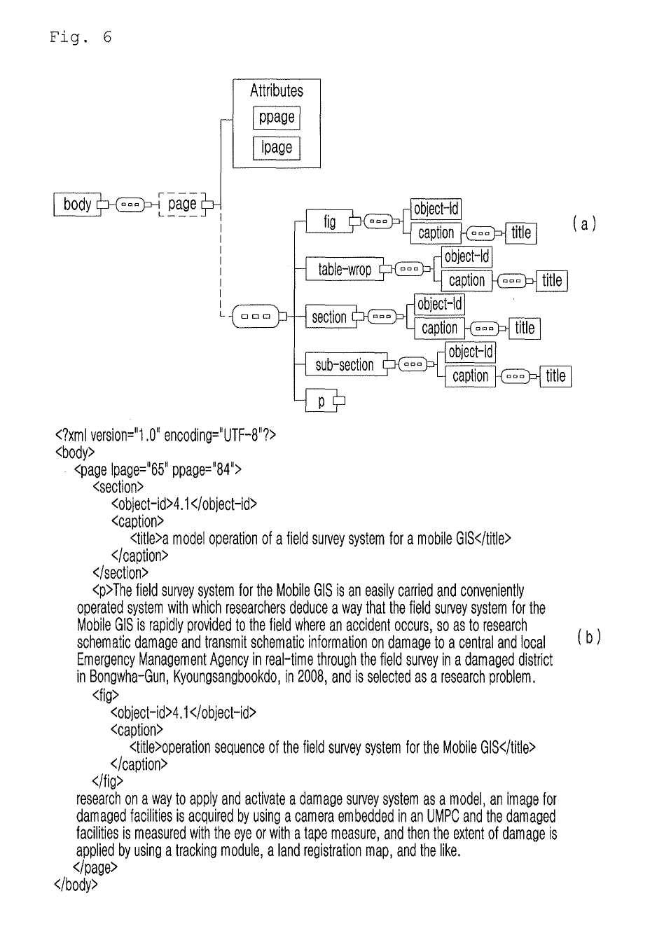

At this time, the XML schema acquired through the schema acquiring unit 51 is shown in FIG. 6A, and the XML data structurized based on the XML reference information is shown in FIG. 6B.

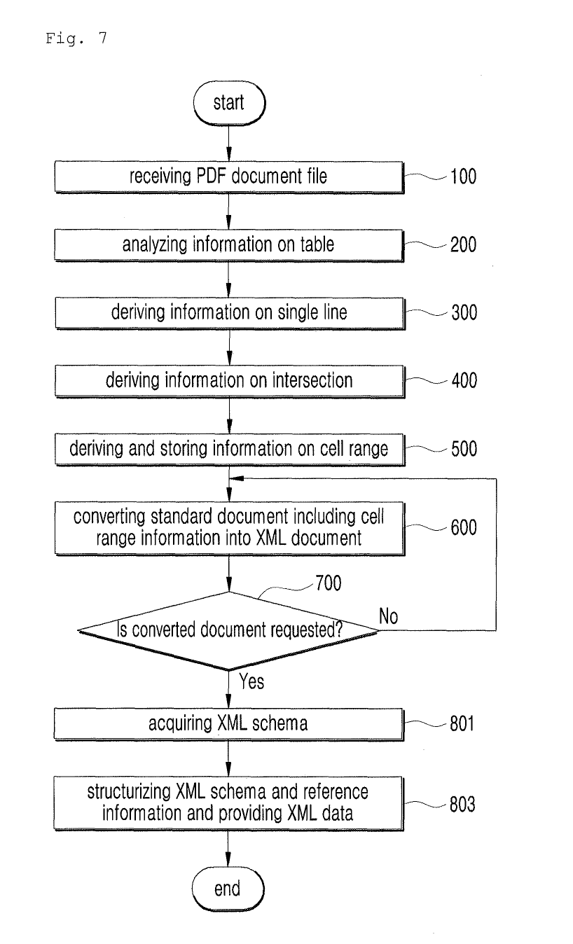

A serial process of analyzing the table of the PDF document file requested to be converted according to the standard operation of the PDF document file, converting the analyzed table into the standard document based on the prescribed reference information, extracting the table as an image of the cell range information instead of the text, converting the standard document including the cell range information corresponding to the table of the converted PDF document into the XML document according to the XML form conversion format, and structurizing and providing the converted XML document according to prescribed XML reference information will be described in detail with reference to FIG. 7.

FIG. 7 is a flowchart illustrating an operation of the electronic form converting apparatus shown in FIG. 1. A process of automatically converting the PDF document file into the XML data according to another embodiment of the present disclosure will be described in detail with reference to FIGS. 1 to 7.

Firstly, the standard document converting unit 10 receives a PDF document file requested to be converted through step 100, and analyzes information on a table of the received PDF document file in step 200.

Then, information on the single line for the table of the PDF document file is derived based on the information on the analyzed table and the prescribed reference information in step 300.

That is, the single line information has a coordinate (x, y) of the starting point and a coordinate (x, y′) of the ending point for each line constituting the prescribed table, as shown in FIG. 4.

Such single line information is provided to an intersection deriving unit 13 of the standard document converting unit 10.

The intersection deriving unit 13 derives an intersection of each line based on the single line information in step 400.

Then, the information on the intersection derived in step 400 is arranged based on information on a coordinate of each intersection of the intersection list in step 500, and in turn the cell range is extracted and stored based on the set A of the intersections which are located at the upper portion, the first intersection L of the set A, the set B of the intersections which are located at the lower portion by reference of the first intersection L, and the first intersection M of the set B of intersections.

The standard document including the cell range information derived by the cell range deriving unit 15 is provided to the XML document generating unit 30.

The XML document generating unit 30 converts the standard document according to the prescribed XML form conversion format information so as to generate the XML document file when the XML form conversion information is input in step 600, and then provides the generated XML document file to the XML document providing unit 50.

That is, the XML document providing unit 50 structurizes and provides the XML document file converted by the XML document generating unit 30 based on the prescribed XML reference information in response to a conversion document request in step 800 when the converted document request is received in step 700.

Then, the XML document providing unit 50 receives and treats the XML document file of the XML document generating and acquires an XML schema designated in the XML data stream from the prescribed schema repository in step 801, and acquires the reference information designated in the input XML document file so as to structurize the XML document file to the converted XML data based on the acquired reference information and the XML schema and to provide the converted XML data in step 803.

At this time, the acquired XML schema is shown in FIG. 6A, and the XML data structurized based on the XML reference information is shown in FIG. 6B.

According to the embodiment of the present disclosure, after the table is extracted as an image of information on a cell range instead of a text by analyzing the table of the PDF document file requested according to a standard operation of the PDF document file requested to be converted and converting the analyzed table into the standard document based on the prescribed reference information, the standard document including information on cell range corresponding to the table of the converted PDF document is converted into the XML document according to the XML form conversion format. In turn, as the converted XML document file is structurized and stored according to the prescribed XML reference information and the XML schema, the PDF document file is accurately converted into the XML document file which is in turn provided, thereby fundamentally improving the form conversion quality of the document.

Here, the method or process related to an algorithm of the described embodiments of the present disclosure may be implemented in the form of program instruction and recorded in a computer-readable medium. The computer-readable recording medium may include a program instruction, a data file, a data structure, and the like individually, or combinations thereof. The program instruction recorded in the medium may be specially designed and constructed, but may be well known by those skilled in the art of the computer software field. An example of the computer-readable recording medium includes magnetic media such as a hard disc, a floppy disc and a magnetic tape, optical media such as a CD-ROM and a DVD, magneto-optical media such as a floptical disc, and a hardware device, such as a ROM, a RAM, a flash memory, which is specially designed to store and perform the program instruction. An example of the program instruction includes high class language codes, which are executed in a computer by using an interpreter, as well as machine codes which are made by a compiler. The above-mentioned hardware device may be configured to operate as one or more software modules in order to perform the operation of the present disclosure, and similarly the software may function like the hardware device.

Although the present disclosure is described with reference to the preferred embodiment, the present disclosure is not limited to the embodiment while various modifications and changes may be implemented by those skilled in the art to which the present disclosure belongs without departing from the scope and the spirit of the present disclosure in claims attached hereto.

### INDUSTRIAL APPLICABILITY

In the apparatus and the method for automatically converting the PDF document file according to the present disclosure, after a table of the PDF document file requested to be converted is analyzed according to a standard operation of the PDF document file and the analyzed table is converted into a standard document based on prescribed reference information so as to extract the table in the form of an image of cell range information instead of a text, the standard document including the cell range information corresponding to the converted table of the PDF document is converted into an XML document according to an XML form conversion format, and the converted XML document file is structurized and provided according to the prescribed XML reference information and an acquired XML schema. The present disclosure can be applied to the conventional technology such as the electronic form conversion system in view of providing the present disclosure to an electronic form conversion environment in which a form conversion quality of the document can be fundamentally improved, and has a sufficient industrial applicability since an apparatus which is a subject to which the related technology is used and applied can be actually embodied.

1. An apparatus for converting an electronic form, the apparatus comprising:
a standard document converting unit configured to extract information on a table which is analyzed according to a standard operation of a Portable Document Format (PDF) document file requested to be converted as information on a single line having a starting point and an ending point based on prescribed reference information, to derive information on an intersection having at least one common starting point or ending point from the single line information, and to extract and store cell range information based on the intersection information;
an eXtensible Markup Language (XML) document generating unit configured to convert a standard document having cell range information according to information on a prescribed XML form conversion format so as to generate an XML document file, when an XML form conversion request is input; and
an XML document providing unit configured to XML structurize and provide the XML document file based on prescribed XML reference information in response to a conversion document request.

2. The apparatus as claimed in claim 1, wherein the XML document providing unit comprises:
a schema acquiring unit configured to receive and treat the XML document file of the XML document generating unit and to acquire an XML schema designated in an XML data stream from a schema repository; and
a storing unit configured to acquire reference information designated in the received XML document file, and to structurize and convert the XML document file into XML data based on the acquired reference information and the XML schema so as to provide the XML data.

3. A method of converting an electronic form, the method comprising:
generating a standard document in a standard document converting unit, which comprises extracting single line information having a starting point and an ending point, based on prescribed reference information from information on a table which is analyzed according to a standard operation of a Portable Document Format (PDF) document file requested to be converted, deriving information on an intersection, deriving intersection information from the single line information, and extracting cell range information from the intersection information;
generating an XML document in an XML document generating unit, which comprises generating an XML document file by converting the standard document including the cell range information according to XML form conversion information, when the XML form conversion information is input;
and
providing an XML document in an XML document providing unit, which comprises XML structurizing the XML document according to prescribed reference information in response to a conversion document request of the XML document generating unit.

4. The method of converting an electronic form as claimed in claim 3, wherein in the XML document providing, a schema acquiring unit receives and treats an XML document file in the XML document generating and acquires an XML schema designated in XML data stream from prescribed schema repository, and
a storing unit configured to acquire reference information designated in the received XML document file, and to structurize and convert the XML document file into XML data based on the acquired reference information and the XML schema so as to provide the XML data.
